(19) United States
(12) Patent Application Publication
(10) Pub. No.: US 2015/0113389 A1
(43) Pub. Date: Apr. 23, 2015

(54) APPARATUS AND METHOD FOR LOADING WEB PAGE

(71) Applicant: Seungil KIM, Seoul (KR)

(72) Inventors: Seungil KIM, Seoul (KR); Hyunoh OH, Seoul (KR); Jaechan LEE, Seoul (KR)

(21) Appl. No.: 14/517,921

(22) Filed: Oct. 20, 2014

(30) Foreign Application Priority Data
Oct. 18, 2013 (KR) 10-2013-0124892
Oct. 18, 2013 (KR) 10-2013-0124899

(51) Int. Cl. G06F 17/21; H04W 4/00; H04L 29/08

(52) U.S. Cl. CPC G06F 17/211; H04L 67/02; H04W 4/008
USPC 715/249

(57) ABSTRACT

Disclosed are a method for loading a web page and an electronic apparatus that performs the same. An exemplary embodiment of the present invention provides an electronic apparatus including: a communication module; a memory; and a controller configured to judge whether a corresponding region is a communication shadowing region, receive a request signal for requesting a target web page, set a web page loading mode, which includes a first mode and a second mode, based on whether the corresponding region is the communication shadowing region, acquire the web page data regarding the target web page according to the set web page loading mode, and display the target web page through the display by using the acquired target web page data.

### CROSS-REFERENCE TO RELATED APPLICATIONS

This application claims priority to and the benefit of Korean Patent Application No. 10-2013-0124892 filed in the Korean Intellectual Property Office on Oct. 18, 2013, and Korean Patent Application No. 10-2013-0124899 filed in the Korean Intellectual Property Office on Oct. 18, 2013, the entire contents of which are incorporated herein by reference.

### TECHNICAL FIELD

The present invention relates to a method for loading a web page and an electronic apparatus that performs the same, and more particularly, to a method for loading a web page, which loads a web page in different modes according to whether a corresponding region is a communication shadowing region and an electronic apparatus that performs the same.

### BACKGROUND ART

In recent years, mobile Internet has been routinely used with development of a mobile communication network. The mobile Internet indicates an Internet service of a developed pattern, which is capable of performing a web browsing service, mail transmission and reception, information searching, Internet communication, an on-line game, and the like via the Internet while moving by using a mobile apparatus such as a smart phone, a tablet, or a personal digital assistant (PDA).

A wireless network needs to be accessed in order to use the mobile Internet. A representative example of the wireless network for the mobile Internet may include a mobile communication network such as LTE or Wibro and a wireless local area network Wi-Fi, and the like.

However, even though communication network coverage has been gradually extended by a communication network provider in recent years, a communication shadowing region is present in the wireless network unlike a general wired network, and there is a problem in that Internet accessing is temporarily limited when entering the communication shadowing region.

Meanwhile, “Streaming” is a technology that reproduces voice or a moving picture on the Internet in real time, and represents a technology that can process transmitted data like an unceasing and continuous water flow.

In general, a method for reproducing multimedia contents such as the voice or the video on a web may be largely classified into a downloading method and a streaming method. In the downloading method, an entire file is stored in a client and thereafter, is reproduced, whereas in the streaming method, the client receives a data segment required for reproduction and temporarily stores the received data segment in a buffer, reads the data temporarily stored in the buffer by using a multimedia reproduction program to immediately process the read data, and reproduces multimedia by converting the data into sound or an image. Therefore, a capacity of a storage medium is not substantially limited, not the entire file but only a required part is transmitted such that communication traffic is reduced, and there is no stand-by time required for full downloading. Accordingly, in recent years, a streaming service has been widely used in some VOD services or Internet broadcasting.

However, when a network speed is lower than a bit rate of multimedia in the streaming service, the data stored in the buffer cannot follow a reproduction speed, and as a result, the multimedia may not be smoothly reproduced, and particularly, it is difficult to smoothly reproduce the multimedia under the environment such as the mobile Internet where Internet connection is instable.

### SUMMARY OF THE INVENTION

The present invention has been made in an effort to provide a method for loading a web page, which loads the web page in different modes according to whether a corresponding region is a communication shadowing region and an electronic apparatus that performs the same.

Objects to be solved by the present invention are not limited to the aforementioned objects and unmentioned objects will be clearly understood by those skilled in the art from the specification and the appended claims.

An exemplary embodiment of the present invention provides an electronic apparatus including: a display; a communication module configured to perform communication with a web server; a memory configured to store information regarding a pre-visited web page; and a controller configured to judge whether a corresponding region is a communication shadowing region, receive a request signal for requesting a target web page, set a web page loading mode, which includes a first mode to acquire web page data regarding the target web page by referring to information regarding the pre-visited web page stored in the memory and a second mode to acquire the web page data regarding the target web page from the web server through the communication module, based on whether the corresponding region is the communication shadowing region, acquire the web page data regarding the target web page according to the set web page loading mode, and display the target web page through the display by using the acquired target web page data.

Another exemplary embodiment of the present invention provides a method for loading a web page, including: judging whether a corresponding region is a communication shadowing region; receiving a signal for requesting a target web page; setting a web page loading mode, which includes a first mode to acquire web page data regarding the target web page by referring to information regarding a pre-visited web page stored in a memory and a second mode to acquire the web page data regarding the target web page through communication with a web server, based on whether the corresponding region is the communication shadowing region; acquiring the web page data regarding the target web page according to the set web page loading mode; and displaying the target web page by using the acquired target web page data.

Moreover, the present invention is directed to an electronic device and a method for performing data streaming that substantially obviates one or more problems due to limitations and disadvantages of the related art.

It is, therefore, an object of the present invention to provide an electronic device and a method for performing data streaming that secure a sufficient amount of buffer sizes in advance when a communication state is excellent so that buffer underrun or buffer underflow does not occur, when entering a communication shadowing region is anticipated.

To achieve these and other advantages and in accordance with the purpose of the invention, as embodied and broadly described herein, an exemplary embodiment of the present invention provides an electronic device reproducing multimedia contents through a streaming service, the device comprising: a communication module configured to communicate with an external device; a memory configured to store map data regarding a communication shadowing region; and a controller configured to: obtain position information on a position of the electronic device, determine whether entering to the communication shadowing region is predicted based on the position information and the map data, receive, via the communication module, streaming data regarding the multimedia contents, and adjust a size of a streaming buffer for storing the streaming data based on a result of the determining.

Another exemplary embodiment of the present invention provides a method for performing reproducing multimedia contents through a streaming service, wherein the method is performed by an electronic device, the method comprising: obtaining position information on a position of the electronic device; determining whether entering to the communication shadowing region is predicted based on the position information and map data regarding a communication shadowing region; receiving streaming data regarding the multimedia contents by communicating with an external device, and adjusting a size of a streaming buffer for storing the streaming data based on a result of the determining.

Still another exemplary embodiment of the present invention provides a server providing multimedia contents to an electronic device reproducing the multimedia contents through a streaming service, the server comprising: a communication module configured to communicate with the electronic device; a memory configured to store map data regarding a communication shadowing region; and a controller configured to: obtain position information on a position of the electronic device, determine whether entering to the communication shadowing region is predicted based on the position information and the map data, and transmit, via the communication module, streaming data regarding the multimedia data, and adjust a size of a streaming buffer for storing the streaming data which is received at the electronic device based on a result of the determining.

Yet another exemplary embodiment of the present invention provides a method for providing multimedia contents to an electronic device reproducing the multimedia contents through a streaming service, wherein the method is performed by a sever transmitting the multimedia contents to the electronic device, the method comprising: obtaining position information on a position of the electronic device; determining whether entering to the communication shadowing region is predicted based on the position information and map data regarding a communication shadowing region; transmitting streaming data regarding the multimedia contents to the electronic device; and adjusting a size of a streaming buffer for storing the streaming data which is received at the electronic device based on a result of the determining.

Solving means of objects of the present invention is not limited to the aforementioned solving means and unmentioned solving means will be clearly understood by those skilled in the art from the specification and the appended claims.

According to exemplary embodiments of the present invention, a requested web page is provided by using pre-stored web page data in a communication shadowing region, and as a result, a user may implement seamless web browsing.

Effects of the present invention are not limited to the aforementioned effects and unmentioned effects will be clearly understood by those skilled in the art from the specification and the appended claims.

### BRIEF DESCRIPTION OF THE DRAWINGS

FIG. 1 is a block diagram of a web system according to an exemplary embodiment of the present invention.

FIG. 2 is a configuration diagram of an electronic apparatus according to an exemplary embodiment of the present invention.

FIG. 3 is a flowchart of a method for loading a web page according to an exemplary embodiment of the present invention.

FIG. 4 is a diagram illustrating map data regarding a communication shadowing region according to an exemplary embodiment of the present invention.

FIG. 5 is a diagram illustrating information on a pre-visited web page according to the exemplary embodiment of the present invention.

FIGS. 6 to 9 are diagrams illustrating a display screen of a target web page according to an exemplary embodiment of the present invention.

FIG. 10 is a flowchart of a method for performing data streaming according to an exemplary embodiment of the present invention.

FIG. 11 illustrates one example of map data according to an exemplary embodiment of the present invention.

FIG. 12 illustrates another example of map data according to an exemplary embodiment of the present invention.

FIGS. 13 and 14 illustrate one example of a reproduction screen of multimedia contents illustrating that the size of a streaming buffer is adjusted according to an exemplary embodiment of the present invention.

### DETAILED DESCRIPTION

Since exemplary embodiments disclosed in the specification are used to clearly describe the spirit of the present invention for those skilled in the art, the present invention is not limited to the exemplary embodiments disclosed in the specification and it should be analyzed that the scope of the present invention includes a modified example and a transformed example without departing from the spirit of the present invention.

Terminologies used in the specification adopt general terminologies which are presently widely used as possible by considering functions in the present invention, but the terminologies may be changed depending on an intention of those skilled in the art, custom, or emergence of new technology. However, when a specific terminology is defined as a predetermined meaning and used, the meaning of the terminology will be additionally disclosed. Accordingly, the terminology used in the specification should be analyzed based on not a name of the terminology but a substantial meaning of the terminology and a content throughout the specification.

The accompanying drawings of the specification are used to easily describe the present invention and shapes illustrates in the drawings may be enlarged as necessary for help understanding the present invention, and as a result, the present invention is not limited by the drawings.

When it is judged that a detailed description of a known configuration or function associated with the present invention obscures the spirit of the present invention, the detailed description thereof will be omitted as necessary.

According to an aspect of the present invention, an electronic apparatus, comprising: a display; a communication module configured to perform communication with a web server; a memory configured to store information regarding a pre-visited web page; and a controller configured to judge whether a corresponding region is a communication shadowing region, receive a request signal for requesting a target web page, set a web page loading mode, which includes a first mode to acquire web page data regarding the target web page by referring to information regarding the pre-visited web page stored in the memory and a second mode to acquire the web page data regarding the target web page from the web server through the communication module, based on whether the corresponding region is the communication shadowing region, acquire the web page data regarding the target web page according to the set web page loading mode, and display the target web page through the display by using the acquired target web page data.

Herein, the controller may set the web page loading mode to the first mode when the corresponding region corresponds to the communication shadowing region, and set the web page loading mode to the second mode when the corresponding region does not correspond to the communication shadowing region.

Herein, the controller may display the target web page by acquiring the web page data regarding the target web page according to the second mode as the corresponding region corresponds to the communication shadowing region, and newly acquires the web page data regarding the target web page according to the second mode when the corresponding region does not correspond to the communication shadowing region, and display the target web page through the display by using the newly acquired target web page data.

Herein, the controller may judge whether the corresponding region is the communication shadowing region, based on strength of a communication signal of the communication module.

Herein, the communication module may include at least one of a mobile communication module performing communication by using a mobile communication network and a short-range communication module performing communication by using a short-range communication network.

Herein, the memory may store the map data regarding the communication shadowing region, and the controller may acquire positional information regarding a current position and judges whether the corresponding region is the communication shadowing region, by using the map data and the positional information.

Herein, the controller may calculate the positional information based on a GPS signal or a Wi-Fi signal.

Herein, the controller may display an icon, which reflects whether the web page data regarding the target web page is acquired according to any mode of the first mode and the second mode, together with the target web page through the display.

Herein, the controller may adjust a display attribute of the target web page according to whether the web page data regarding the target web page is acquired according to any mode of the first mode and the second mode.

Herein, information regarding the pre-visited web page may include time information regarding a time of visiting the pre-visited web page, and the controller may display the time of visiting the visited web page or a time different from a current time to the visitation time by using the time information, together with the target web page through the display, when the web page loading mode is set to the first mode.

Herein, the controller may judge whether the corresponding region is to enter the communication shadowing region, updates the information regarding the pre-visited web page by using the data regarding the target web page received through the second mode, and determine whether the updating is performed based on whether the corresponding region is to enter the communication shadowing region.

According to another aspect of the present invention, a method for loading a web page, comprising: judging whether a corresponding region is a communication shadowing region; receiving a signal for requesting a target web page; setting a web page loading mode, which includes a first mode to acquire web page data regarding the target web page by referring to information regarding a pre-visited web page stored in a memory and a second mode to acquire the web page data regarding the target web page through communication with a web server, based on whether the corresponding region is the communication shadowing region; acquiring the web page data regarding the target web page according to the set web page loading mode; and displaying the target web page by using the acquired web page data.

According to still another aspect of the present invention, an electronic device reproducing multimedia contents through a streaming service may be provided, the device comprising: a communication module configured to communicate with an external device; a memory configured to store map data regarding a communication shadowing region; and a controller configured to: obtain position information on a position of the electronic device, determine whether entering to the communication shadowing region is predicted based on the position information and the map data, receive, via the communication module, streaming data regarding the multimedia contents, and adjust a size of a streaming buffer for storing the streaming data based on a result of the determining.

According to still another aspect of the present invention, a server providing multimedia contents to an electronic device reproducing the multimedia contents through a streaming service may be provided, the server comprising: a communication module configured to communicate with the electronic device; a memory configured to store map data regarding a communication shadowing region; and a controller configured to: obtain position information on a position of the electronic device, determine whether entering to the communication shadowing region is predicted based on the position information and the map data, and transmit, via the communication module, streaming data regarding the multimedia data, and adjust a size of a streaming buffer for storing the streaming data which is received at the electronic device based on a result of the determining.

Herein, the controller may increase the size of the streaming buffer when the entering is predicted.

Herein, when being in the communication shadowing region the controller may determine whether evacuating from the communication shadowing region is predicted based on the position information and the map data, and decrease the increased size of the streaming buffer when the evacuating is predicted.

Herein, the controller may decrease the increased size of the streaming buffer further considering a size of the streaming data stored in the streaming buffer.

Herein, the controller may set the size of the streaming buffer to a first size when the entering is not predicted and set the size of the streaming buffer to a second size greater than the first size when the entering is predicted.

Herein, the controller may adjust the size of the streaming buffer further considering a reproduction speed of the multimedia contents.

Herein, the controller may adjust at least one of a receiving speed of the streaming data, a bit rate of the multimedia contents and a resolution of the multimedia contents based on the result of the determining.

Herein, the controller may determine that the entering is predicted when the position is within a predetermined distance from a boundary of the communication shadowing region.

Herein, the controller may obtain movement information including at least one of a movement speed and a movement direction and determine whether the entering is predicted further considering the movement information.

Herein, the map data may include information on the communication shadowing region, a neighboring region of the communication shadowing region, and a communication region, and the controller may determine whether the entering is predicted based on whether the position is changed from the communication region to the neighboring region.

According to still another aspect of the present invention, a method for performing reproducing multimedia contents through a streaming service may be provided, wherein the method is performed by an electronic device, the method comprising: obtaining position information on a position of the electronic device; determining whether entering to the communication shadowing region is predicted based on the position information and map data regarding a communication shadowing region; receiving streaming data regarding the multimedia contents by communicating with an external device, and adjusting a size of a streaming buffer for storing the streaming data based on a result of the determining.

According to yet another aspect of the present invention, a method for providing multimedia contents to an electronic device reproducing the multimedia contents through a streaming service may be provided, wherein the method is performed by a sever transmitting the multimedia contents to the electronic device, the method comprising: obtaining position information on a position of the electronic device; determining whether entering to the communication shadowing region is predicted based on the position information and map data regarding a communication shadowing region; transmitting streaming data regarding the multimedia contents to the electronic device; and adjusting a size of a streaming buffer for storing the streaming data which is received at the electronic device based on a result of the determining.

Herein, the adjusting may include increasing the size of the streaming buffer when the entering is predicted.

Herein, the method may further comprise determining whether evacuating from the communication shadowing region is predicted based on the position information and the map data when being in the communication shadowing region, and decreasing the increased size of the streaming buffer when the evacuating is predicted.

Herein, in the decreasing, the increased size of the streaming buffer may be decreased further considering a size of the streaming data stored in the streaming buffer.

Herein, the adjusting may include setting the size of the streaming buffer to a first size when the entering is not predicted and setting the size of the streaming buffer to the second size greater than the first size when the entering is predicted.

Herein, in the adjusting, the size of the streaming buffer may be adjusted further considering a reproduction speed of the multimedia contents.

Herein, the method may further comprise adjusting at least one of a receiving speed of the streaming data, a bit rate of the multimedia contents and a resolution of the multimedia contents based on the result of the determining.

Herein, in the determining, the entering may be predicted when the position is within a predetermined distance from a boundary of the communication shadowing region.

Herein, the method may further comprise obtaining movement information including at least one of a movement speed and a movement direction, wherein in the determining, whether the entering is predicted is determined further considering the movement information.

Herein, the map data may include information on the communication shadowing region, a neighboring region of the communication shadowing region, and a communication region, and in the determining whether the entering is predicted may be determined based on whether the position is changed from the communication region to the neighboring region.

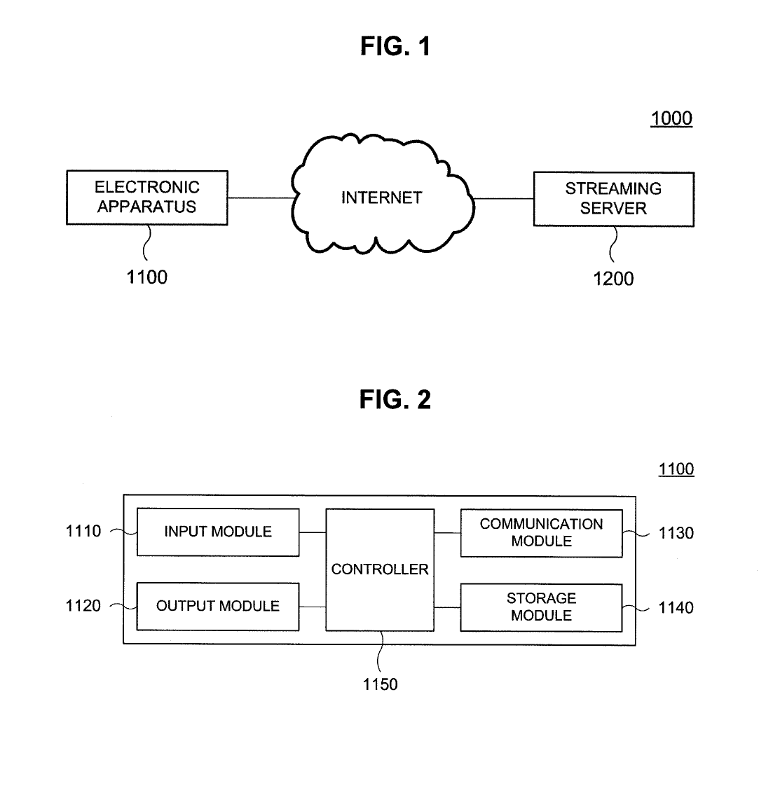

Hereinafter, a web system 1000 according to an exemplary embodiment of the present invention will be described with reference to FIG. 1. FIG. 1 is a block diagram of the web system 1000 according to an exemplary embodiment of the present invention.

The web system 1000 according to the present invention may provide a mobile web browsing service. Furthermore, the web system 1000 according to the present invention may provide a streaming service. The streaming service is a technique that reproduces voice or an image, an animation, and the like on the Internet in real time, and is a technique that reproduces contents by receiving a segment required to reproduce data regarding multimedia contents from the Internet and simultaneously processing the received data segment in real time, unlike reproducing multimedia contents such as a moving picture or music after receiving all files in order to enjoy the multimedia contents on the Internet in the related art. As a result, since the multimedia contents may be reproduced immediately by using a client browser or a plug-in even before all of the files are transmitted, no time is required to download the files, and as a result, a user can substantially enjoy multimedia without a stand-by time and a capacity of a storage device is not almost influenced. However, the streaming service in the present invention needs to be analyzed as a broad concept including not only a narrow streaming service to receive data of multimedia contents such as RTMP/RTSP streaming or adaptive HTTP streaming by the unit of a segment but also a pseudo streaming service such as progressive streaming or HTTP pseudo streaming of a method in which the multimedia contents are produced immediately after the file is reached while downloading the multimedia contents from a web server.

Referring to FIG. 1, the web system 1000 according to the present invention includes an electronic apparatus 1100 and a server 1200. Herein, the electronic apparatus 1100 and the server 1200 may access a mobile Internet network through a mobile communication network or a wireless short-range communication network to transmit and receive data to and from each other. Further, the electronic apparatus 1100 and the server 1200 may be connected to each other through a mobile communication base station or a repeater such as a Wi-Fi access point (AP). However, the server 1200 in the present invention needs to be analyzed as a comprehensive concept including both a streaming server that supports a streaming service function and a web server that performs progressive downloading.

The electronic apparatus 1100 may receive a request for a web page from a user to provide the user with the web page. To this end, the electronic apparatus 1100 may receive data (hereinafter, referred to as ‘web page data’) for providing the web page from the web server 1200 or display the web page by referring to the web page data pre-stored in the electronic apparatus 1100 to provide the requested web page.

Furthermore, the electronic device 1100 may reproduce multimedia contents through the streaming service. To this end, the electronic device 1100 requests the multimedia contents from the server 1200, receives data regarding the multimedia contents from the server 1200, stores the received data in a streaming buffer, and reproduces the multimedia contents by using the data stored in the streaming buffer, thereby providing the streaming service. Herein, the electronic device 1100 may directly request the multimedia contents from the server 1200 or indirectly request the multimedia contents from the server 1200 through another web server.

According to the present invention, the server 1200 may include at least one of a web server and a streaming server. The web server may provide the web page data to the electronic apparatus 1100. The web server may receive the request for the web page from the electronic apparatus 1100 and transmit the web page data regarding the requested web page to the electronic apparatus 1100 in response thereto. Herein, the web server may transmit the web page data directly stored in the web server to the electronic apparatus 1100 or acquire the web page data from a database server (not illustrated) storing the web page data to transmit the acquired web page data to the electronic apparatus 1100.

Meanwhile, a process in which the electronic apparatus 1100 performs the aforementioned series of web browsing services may be performed by driving a web browser or a web browsing program, and similarly, the process in which the web server performs the aforementioned series of web browsing services may be performed by driving a web server program.

On the other hand, the streaming server may provide the multimedia contents to the electronic device 1100. When the streaming server stores the multimedia contents, and thereafter, receives a signal for requesting the stored multimedia contents from the electronic device 1100, the streaming server may transmit the data regarding the multimedia contents to the electronic device 1100. In this case, the data regarding the multimedia contents may be separated into a plurality of segment units and the streaming server may first transmit a data segment corresponding to a position where a user desires to enjoy the multimedia contents among the multimedia contents.

Alternatively, the streaming server may acquire the data of the multimedia contents from a database server (not illustrated), which stores the multimedia contents, instead of autonomously storing the multimedia contents, thereby transmitting the acquired data to the electronic device 1100. Herein, the database server (not illustrated) may be physically integrated with the server 1200 or exist outside separately.

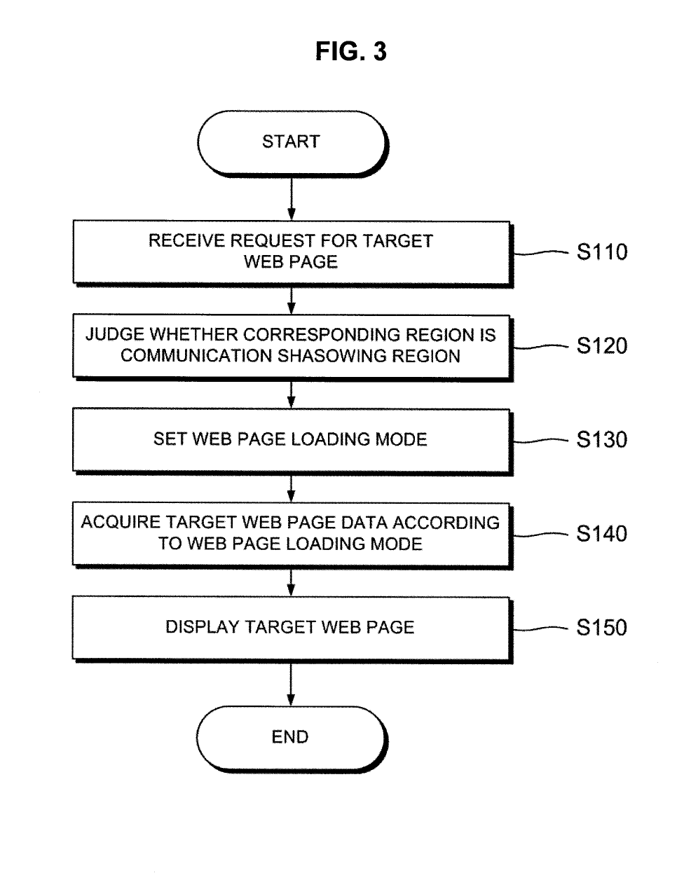

Hereinafter, the electronic apparatus 1100 according to the exemplary embodiment of the present invention will be described with reference to FIG. 2. FIG. 2 is a block diagram of the web system 1000 according to the exemplary embodiment of the present invention.

As described above, the electronic apparatus 1100 may represent an apparatus that operates as a client providing the web browsing service by accessing the mobile Internet. Examples of the apparatus may include a smart phone, a tablet, a phablet, a PDA, a navigation terminal, a digital multimedia broadcasting (DMB) terminal, a notebook computer, and the like. However, the electronic apparatus 1100 is not limited to the aforementioned examples.

Referring to FIG. 2, the electronic apparatus 1100 may include an input module 1110, an output module 1120, a communication module 1130, a memory 1140, and a controller 1150.

The input module 1100 may receive a user input from the user.

The input module 1110 is a comprehensive concept including all of a traditional type of keypad or keyboard, a mouse, a touch sensitive module sensing a touch of the user, a microphone receiving a voice signal, a camera module recognizing a gesture, or the like through image recognition, an illuminance sensor sensing the user input according to a change in illuminance, a motion sensor recognizing a motion through an acceleration sensor or a gyro sensor, and various types of input means sensing or receiving various types of user inputs. Herein, the touch sensitive module may include a piezoelectric touch module or a capacitive touch module sensing a touch through a touch panel attached to a display panel or an optical touch module sensing a touch by an optical method. Further, the input module 1110 may also be implemented as a form of a port type input interface that connects the electronic apparatus 1100 with an external input apparatus receiving the user input, instead of being implemented as an apparatus autonomously sensing the user input.

The output module 1120 may output various types of information to the user.

The output module 1120 is a comprehensive concept including all of a display outputting a video, a speaker outputting sound, a haptic device generating vibration, and various other types of output means.

Herein, the display may display a text, an image, a moving picture, or various other types of information. The display is a concept that represents an extended video display apparatus that includes all of a liquid crystal display (LCD), a light emitting diode (LED) display, an organic light emitting diode (OLED) display, a flat panel display (FPD), a transparent display, a flexible display, a 3-dimensional (3D) display, a holographic display, and various types of displays capable of performing other video displaying functions. Further, the output module 1120 may also be implemented as a form of a port type output interface that connects the electronic apparatus 1100 with the aforementioned individual output means.

Meanwhile, the input module 1110 and the output module 1120 may also be integrally implemented as a form of a touch display.

The communication module 1130 may communicate with an external apparatus. In particular, in the present invention, the communication module 1130 may receive the data regarding the multimedia contents for the streaming service through communication with the streaming server 1200 by accessing the Internet network. In the present invention, the communication module 1130 may include at least one of a wired communication module using a wired communication network, a mobile communication module using a mobile communication network, a short-range communication module using a wireless short-distance communication network, and a satellite communication module using a satellite communication network.

The wired communication module may communicate with an external device by using the wired communication network. Herein, the wired communication network may be a wired LAN, and the like. The wired communication module may access the Internet network via the wired communication network and transmit data to the server 1200 that accesses the Internet network or receive data from the server 1200.

The mobile communication module may communicate with the external apparatus by using the mobile communication network. Herein, the mobile communication network may include communication networks according to various specifications including CDMA, GSM, CDS, cdmaOne, HSCSD, CDMA2000, UMTS, WCDMA, EV-DO, HSDPA, HSPA+, LTE, LTE-advanced, WiMAX, Wibro, OFDM, and the like. The mobile communication module may access the Internet network via a base station by using the mobile communication network and transmit data to the server 1200 that accesses the Internet network or receive data from the server 1200.

The short-range communication module may communicate with the external apparatus by using the short-range communication network. Herein, the short-range communication network may include a wireless local area network (WLAN) series communication network such as Wi-Fi and a wireless personal area network (WPAN) series communication network such as Bluetooth. The short-range communication module may also access the Internet network through an access point. As a result, the short-range communication module may transmit data to the server 1200 that accesses the Internet network or receive data from the server 1200. Further, the short-range communication module may also acquire position information regarding a present position by using a communication signal with an AP of the short-range communication network.

The satellite communication module may access the satellite communication network. As a result, the satellite communication module may communicate with the server 1200 by accessing the Internet network via a satellite through the satellite communication network.

Further, the satellite communication module may receive a satellite signal of a global navigation satellite system (GNSS) including a global positioning system (GPS) or a global navigation satellite system (GLONASS), and a European satellite navigation system (GALILEO) from a satellite, and the electronic apparatus 1100 may calculate a current position of the electronic apparatus 1100 based on the satellite signal.

Meanwhile, since the communication module 1130 is not limited to the aforementioned examples, the communication module 1130 may be implemented in various forms in addition to the aforementioned communication module 1130. As one example, the communication module 1130 may be a DMB module that receives a DMB signal.

The memory 1140 may store various pieces of information. The memory 1140 may store data semi-permanently or temporarily. Further, the memory 1140 may be provided in a form incorporated in the electronic apparatus 1100 or a form detachable from or attachable to the electronic apparatus 1100. Examples of the memory 1140 may include a hard disk drive (HDD), a solid state drive (SSD), a flash memory, a read-only memory (ROM), a random access memory (RAM), and the like. The memory 1140 may store various types of data required or used to drive the electronic apparatus 1100, such as an operating program (OS, operating system) for driving the electronic apparatus 1100, a web browser program, or information on a web page which is pre-visited.

The controller 1150 controls an overall operation of the electronic apparatus 1100. To this end, the controller 1150 may calculate and process various pieces of information and control operations of components of the electronic apparatus 1100.

The controller 1150 may be implemented as a computer or a similar apparatus according to hardware, software or a combination thereof. The controller 1150 may be provided in a form of an electronic circuit that performs a control function by processing an electric signal in terms of the hardware and in a form of a program that drives the hardware controller 1150 in terms of the software.

Meanwhile, otherwise separately mentioned in describing a method for loading the web page, which is to be described below, it may be analyzed that the operation of the electronic apparatus 1100 is performed by a control of the controller 1150.

Hereinafter, the method for loading the web page according to the exemplary embodiment of the present invention will be described. Herein, it will be described that the method for loading the web page according to the exemplary embodiment of the present invention is performed by the web system 1000 including the electronic apparatus 1100 and the server 1200 (web server). However, the description is only for convenience of description, and the method for loading the web page is not particularly performed only by the electronic apparatus 1100 and the server 1200 and may be performed by another apparatus or system which is the same as or similar to the electronic apparatus 1100 and the server 1200.

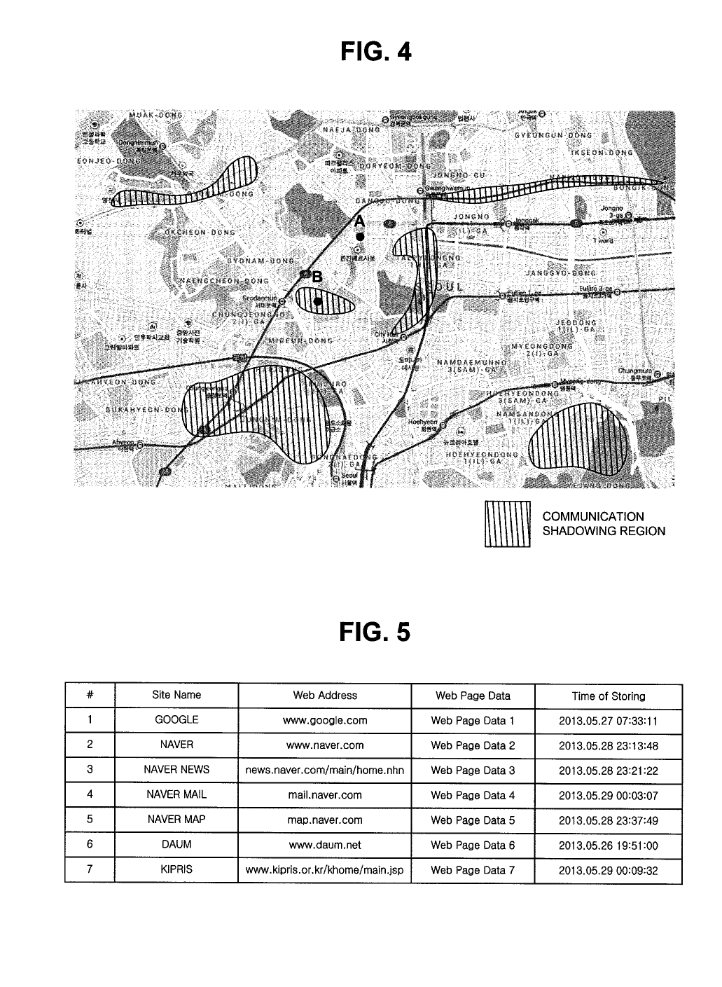

FIG. 3 is a flowchart of a method for loading a web page according to an exemplary embodiment of the present invention.

Referring to FIG. 3, the method for loading the web page according to the exemplary embodiment of the present invention may include receiving a request for a target web page (S110), judging whether a corresponding region is a communication shadowing region (S120), setting a web page loading mode based on whether the corresponding region is the communication shadowing region (S130), acquiring web page data regarding the target web page according to the set web page loading mode (S140), and displaying the target web page by using the acquired web page data (S150). Hereinafter, the aforementioned respective steps will be described in detail.

The electronic apparatus 1100 receives a request for the target web page (S110).

The controller 1150 may receive a request signal for requesting a predetermined web page (hereinafter, referred to ‘target web page’) according to the user input which is input through the input module 1110.

The input module 1110 may receive various types of user inputs, and the controller 1150 may receive a request signal for requesting an address of the target web page according to various types of user inputs. Herein, the request signal may include information on an address of the target web page.

The input module 1110 may directly receive the address of the target web page from the user. For example, the electronic apparatus 1100 may drive the web browser and the user may input the address of the target web page into a web page address window provided by the web browser. Herein, the address of the target web page may be a URL address, an IP address, a domain name, or the like. In this case, since the user input includes the address of the target web page, the controller 1150 may acquire a request signal for requesting the target web page.

Alternatively, the input module 1110 may receive an input for selecting a link, which is connected to the address of the target web page, from the user. For example, the user may select the link connected to the target web page displayed on the web page while the electronic apparatus 1100 displays the web page. In this case, since the link includes information on the address of the target web page, the controller 1150 may acquire the request signal for requesting the target web page.

Alternatively, the input module 1110 may receive a web browsing command, which is provided in the web browser, from the user. Herein, the web browsing command may include ‘go to home page’, ‘favorites’, ‘renew’, ‘go forward’, ‘go backward’, ‘favorites’, and the like. In this case, the target web page may be determined according to the selected web browsing command, and as a result, the controller 1150 may acquire the request signal for requesting the target web page. For example, when a first web page moves to a second web page, and then the web browsing command corresponding to ‘go backward’ is input by the user input, the target web page may be determined as the first web page.

Further, the input module 1100 may receive the user input for driving the web browser. In general, since a start page is registered in the web browser, the controller 1150 may receive a request signal for requesting the web page, which is registered as the start page, as the target web page.

The electronic apparatus 1100 may judge whether the corresponding region is the communication shadowing region (S120).

Herein, the communication shadowing region may represent a region where wireless communication through the mobile communication network or the wireless short-range communication network is not smoothly performed. For example, the communication shadowing region may mean a region where is out of coverage of the mobile communication network or the wireless short-range communication network or data transmission and reception are unavailable due to a weak communication signal thereof. In the communication shadowing region, the electronic apparatus 1100 may not access the Internet network.

According to one example, in the present invention, the communication shadowing region may be judged based on intensity of a communication signal.

First, the communication module 1130 may sense the intensity of the communication signal. For example, the mobile communication module may sense intensity of a mobile communication signal such as LTE or the short-range communication module may sense intensity of a Wi-Fi signal irradiated from a neighboring access point. The controller 1150 may judge that the target region corresponds to the communication shadowing region when the communication module 1130 does not sense the communication signal or when the sensed intensity of the communication signal is equal to or less than a predetermined reference value. On the contrary, when the intensity of the communication signal sensed by the communication module 1130 is equal to or more than the predetermined reference value, the controller 1150 may judge that the target region does not correspond to the communication shadowing region.

According to another example, in the present invention, the communication shadowing region may be judged based on positional information on a current position.

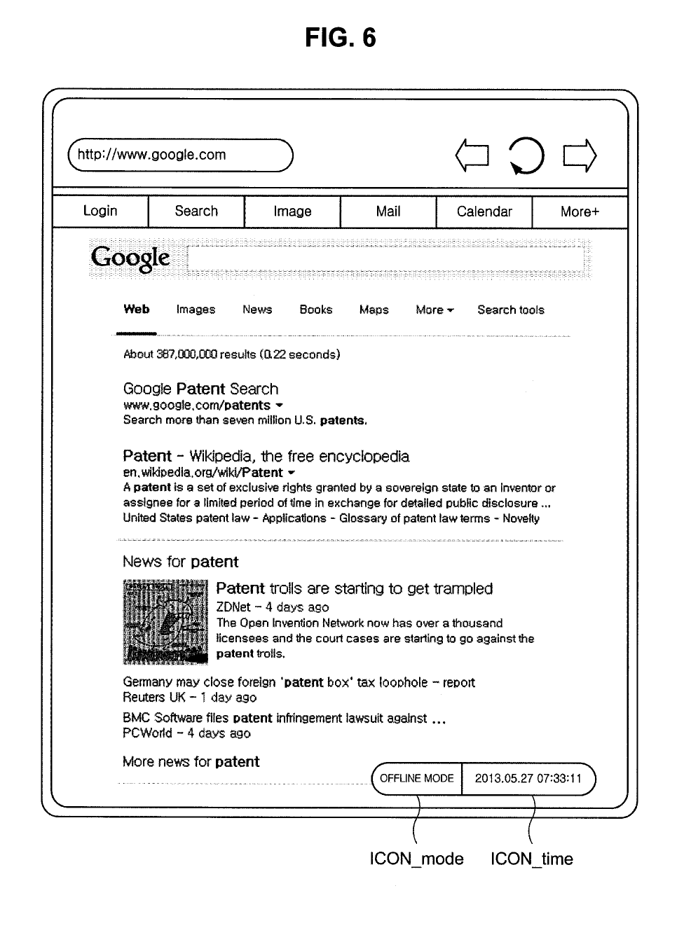

The memory 1140 stores map data regarding the communication shadowing region. FIG. 4 is a diagram illustrating map data regarding a communication shadowing region according to an exemplary embodiment of the present invention. Referring to FIG. 4, the map data may include information on a region corresponding to the communication shadowing region in a map, information on a region where the communication signal is weak, or information regarding whether a corresponding region corresponds to a local communication shadowing region or information on strength of the communication signal.

The controller 1150 may acquire the positional information on the current position and judge whether the current position is the communication shadowing region by referring to the map data stored in the memory 1140. For example, when the current position of the electronic apparatus 1100 is point A of FIG. 4, the controller 1150 may judge that point A does not correspond to the communication shadowing region by referring to the map data. Similarly, when the current position of the electronic apparatus 1100 is point B of FIG. 4, the controller 1150 may determine that point B belongs to the communication shadowing region by referring to the map data. Herein, the positional information may be calculated through measurement using a GPS signal or a Wi-Fi signal.

The electronic apparatus 1100 may set the web page loading mode (S130).

The controller 1150 may set the web page loading mode based on whether the corresponding point is the communication shadowing region. Herein, the web page loading mode may include an on-line mode to receive and acquire the web page data from the server and an off-line mode to extract desired web page data from web page data of pre-visited web pages stored in the memory 1140.

The controller 1150 may set the web page loading mode to the on-line mode when the corresponding point does not correspond to the communication shadowing region and set the web page loading mode to the off-line mode when the corresponding point corresponds to the communication shadowing region. Detailed operations according to the on-line mode and the off-line mode will be described below.

It has been described above that when the electronic apparatus 1100 receives the request signal for requesting the target web page, the electronic apparatus 1100 judges whether the corresponding point corresponds to the communication shadowing region, in response thereto, and sets the web page loading mode, but the judging of whether the corresponding point corresponds to the communication shadowing region (S120) and the setting of the web page loading mode (S130) need not be particularly performed only when the request signal is received. For example, the electronic apparatus 1100 may judge whether the corresponding point is the communication shadowing region in real time or periodically according to a predetermined time interval, regardless of the reception of the request signal, and as a result, the electronic apparatus 1100 may perform the process of setting the web page loading mode.

The electronic apparatus 1100 may acquire the web page data regarding the target web page according to the set web page loading mode (S140).

When the web page loading mode is the on-line mode, the electronic apparatus 1100 may receive the web page data regarding the target web page from the server 1200. Herein, the server 1200 may be a web server that manages a website including the target web page. In detail, the communication module 1130 transmits an address of the target web page to the server 1200. The server 1200 may transmit the web page data regarding the target web page to the electronic apparatus 1100 by referring to the address of the target web page, and the controller 1150 may receive the web page data through the communication module 1130 to acquire the web page data regarding the target web page.

When the web page loading mode is the off-line mode, the electronic apparatus 1100 may acquire the web page data regarding the target web page by referring to the memory 1140.

In the present invention, the memory 1140 may store information on a pre-visited web page. Herein, the pre-visited web page may mean a web page which the user visited while performing web browsing using the electronic apparatus 1100 in advance. In the present invention, when the electronic apparatus 1100 receives the web page data regarding the corresponding web page from the server 1200 according to the on-line mode in order to provide the web page to the user, the controller 1150 may store the information on the corresponding web page in the memory 1140, and as a result, information on pre-visited web pages may be constructed in the memory 1140 as a database.

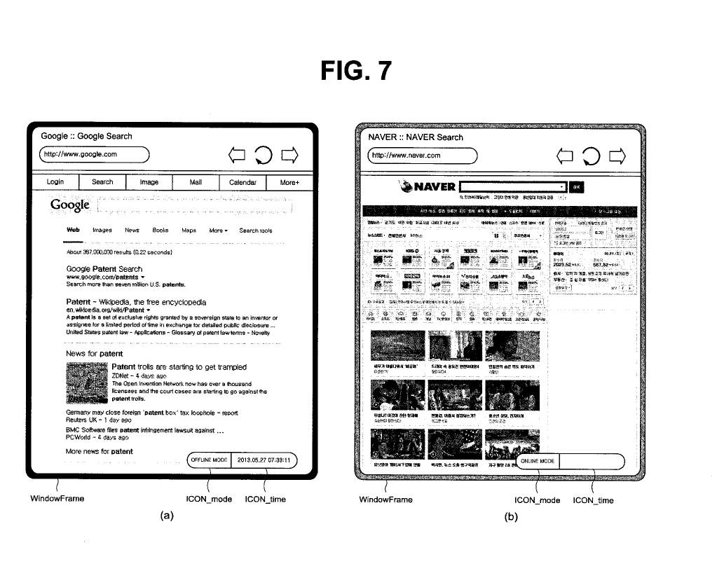

FIG. 5 is a diagram illustrating information on a pre-visited web page according to the exemplary embodiment of the present invention.

Referring to FIG. 5, the information on the pre-visited web page may include address information, web page data, and time information of the pre-visited web page.

When the controller 1150 stores the information on the pre-visited web page in the memory 1140, the controller 1150 may store the web page data received from the server 1200 through the on-line mode and the web page address in the memory 1140 as the information on the pre-visited web page. Further, the electronic apparatus 1100 may store time information, which indicates a time of visiting the pre-visited web page or a time of storing or updating the web page data regarding the pre-visited web page, as the information on the pre-visited web page. In this case, the address information, the time information, and the web page data may be stored by being linked with each other. Besides, the information on the pre-visited web page may further include a site name or a web page name.

Referring to FIG. 5, for example, “www.google.com” which is an address of a web page “Google”, web page data 1 which is required for providing the corresponding web page, and “2013.05.27 07:33:11” dl which is a time of receiving the web page data or a time of visiting the web page may be stored by being linked with each other in the memory 1140. Similarly, information on various pre-visited web pages such as Naver, Naver news, Naver mail, Naver map, Daum, KIPRIS, and the like may be stored in the memory 1140.

The controller 1150 may extract the web page data regarding the target web page, which is included in the request signal, from the web page data of the pre-visited web page stored in the memory 1140 as above. First, the controller 1150 may retrieve an address, which is the same as the address of the target web page, from the address information of the pre-visited web page and acquire web page data linked with the retrieved address as the web page information regarding the target web page.

For example, when the user inputs a request signal for requesting “www.naver.com” as the target web page, the controller 1150 may acquire second web page data regarding the web page, which is the same as the web page, among the pre-visited web pages, as data regarding the target web page.

As another example, in the process in which the electronic apparatus 1100 receives a signal for requesting “www.google.com” from a user while providing the web page of “www.naver.com” to the user according to the on-line mode, and then moves to the web page according to the on-line mode, information on “www.naver.com” and “www.google.com” may be stored as the pre-visited web page in the memory 1140. In this situation, when the electronic apparatus 1100 enters the communication shadowing region due to the movement of the user, the web page loading mode is set to the off-line mode, and then a user input of selecting a ‘go backward’ icon, which is provided in the web browser, is input, the controller 1150 may acquire the web page data regarding “www.naver.com”, which is the target web page by the ‘go backward’ icon, as web page data 2, which is web page data regarding the web page having the same address, by retrieving the information regarding the pre-visited web page.

The electronic apparatus 1100 may display the target web page by using the acquired web page data (S150).

The controller 1150 may display the target web page through the display by using the web page data acquired according to the set web page loading mode. The target web page may be displayed in the manner which is the same as or similar to a method of displaying the web page by a generally known web browser.

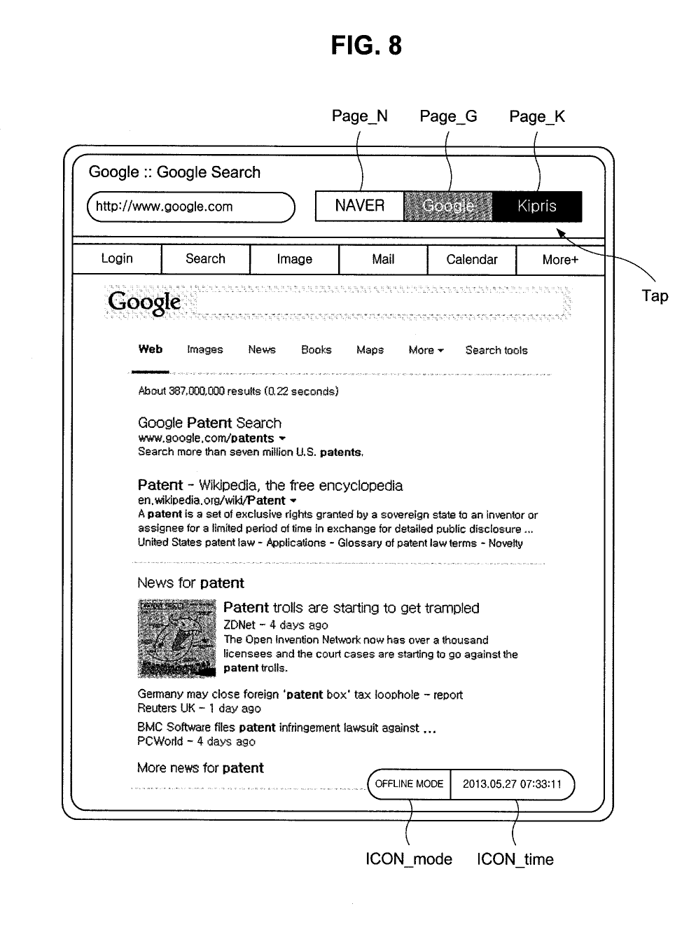

FIGS. 6 to 9 are diagrams illustrating a display screen of a target web page according to an exemplary embodiment of the present invention.

The electronic apparatus 1100 may display information that reflects the web page loading mode to load the target web page. Referring to FIG. 6, the display may display an icon ICON_mode that reflects the web page loading mode together with the target web page.

Further, when the electronic apparatus 1100 loads the target web page according to the off-line mode, information ICON_time regarding a time when the web page data used as the web page data regarding the target web page is stored in the memory 1140 may be displayed together with the target web page. The controller 1150 may acquire the pre-visit time by using the time information linked with the web page data, which is extracted as the web page data regarding the target web page by referring to the memory 1140, and display the acquired pre-visitation time. Herein, the electronic apparatus 1100 may also display information on displaying the target web page by using the web page data, which is acquired earlier by a predetermined time from a current time, based on the visitation time and the current time, instead of the time of storing the web page data.

Further, the electronic apparatus 1100 may adjust a display attribute of a web browser window, which displays the target web page, according to the web page loading mode to load the target web page. For example, as illustrated in FIG. 7, in a case of displaying the target web page according to the on-line mode and a case of displaying the target web page according to the off-line mode, colors of window frames of the respective target web pages may be displayed differently from each other. In detail, FIG. 7A illustrates the case of displaying the target web page according to the off-line mode, and FIG. 7B illustrates the case of displaying the target web page according to the on-line mode, and in this case, in FIGS. 7A and 7B, colors of window frames of the respective web browsers may be displayed differently from each other. Herein, the display attribute may include transparency, brightness, a chroma, a form, a size, and the like in addition to a color.

Similarly, when the web browser operates a plurality of web pages in one window, display attributes of taps corresponding to the respective web pages may be adjusted according to a web browsing mode. Referring to FIG. 8, the electronic apparatus 1100 displays taps corresponding to Naver (Page_N), Google (Page_G), and KIPRIS (Page_K) through a web browser. Herein, Google (Page_G) is a web page provided according to the off-line mode, and Naver (Page_N) and KIPRIS (Page_K) are web pages provided according to the on-line mode, and the colors of the taps may be displayed differently from each other.

Meanwhile, when the electronic apparatus 1100 receives the web page data of the target web page from the server 1200 according to the on-line mode, the electronic apparatus 1100 may store the web page data in the memory 1140 as the information regarding the pre-visited web page. When the pre-visited web page having the same address is present in the memory 1140, the controller 1150 may update the information on the pre-visited web page by using newly received web page data and update the storing time as a time of newly receiving the web page data.

Further, the electronic apparatus 1100 may manage the information regarding the pre-visited web page based on the storing time. For example, the controller 1150 may delete from the memory 1140 the information regarding the pre-visited web page in which a predetermined time interval from the storing time to a current time elapsed.

Meanwhile, when the electronic apparatus 1100 deviates from the communication shadowing region under a situation in which the target web page is provided according to the off-line mode because the corresponding region corresponds to the communication shadowing region, the electronic apparatus 1100 may acquire the web page data regarding the target web page according to the on-line mode without a separate user input and newly display the target web page by using the target web page data newly acquired according to the on-line mode.

Alternatively, similarly, when the electronic apparatus 1100 deviates from the communication shadowing region and changes the web page loading mode to the on-line mode under a situation in which the target web page is displayed according to the off-line mode, information indicating that the web page loading mode is changed to the on-line mode may be output to the user. For example, in this situation, the controller 1150 may adjust a color of a renew icon (Icon_renew) of the web browser or make the renew icon glitter, as illustrated in FIG. 9.

Meanwhile, it has been described above that the judging of whether the corresponding region is the communication shadowing region (S120) and the setting of the web page loading mode based on whether the corresponding region is the communication shadowing region (S130) are performed after the receiving of a request for the target web page (S110), but steps S120 and S130 need not particularly be performed only after performing step S110 and may be performed in real time or periodically separately from S110.

Meanwhile, in the present invention, the electronic apparatus 1100 may store the pre-visited web page by a method described below.

First, when the controller 1150 receives the pre-visited web page through the communication module 1130 according to the on-line mode as described above, the controller 1150 may store the information on the web page in the memory 1140.

Herein, when information regarding all of the pre-visited web pages is stored, a storage space of the memory 1140 may be insufficient, and as a result, the controller 1150 may selectively store the information regarding the web page.

For example, the controller 1150 may set a buffer space, which stores the information regarding the pre-visited web page, in the memory 1140 and adjust the size of the buffer space to a predetermined size. The predetermined size may be arbitrarily determined by the controller 1150 or determined according to the user input which is input through the input module 1110. Next, the controller 1150 may store the information regarding the pre-visited web page including the data of the pre-visited web page, which is received through the communication module 1140, in the buffer space. When the size of the buffer space reaches the predetermined size in this situation, a total data amount of the information regarding the pre-visited web page may be configured not to be more than the size of the buffer space by deleting the information regarding the pre-visited web page, which is previously stored, according to a predetermined method at the time of storing information regarding a newly visited web page.

As one example of the predetermined method, the controller 1150 may delete the information regarding the pre-visited web page of which the storing time is earliest based on the storing time. In other words, the information regarding the pre-visited web page of which the storing time is latest is maintained.

As another example of the predetermined method, the controller 1150 may maintain the information regarding the pre-visited web page as many as a predetermined number. For example, in the case where the predetermined number is 100, when information regarding first 100 pre-visited web pages is stored and then information regarding a pre-visited web page, which is visited at the 101^{st} time, is acquired, information or data regarding a first pre-visited web page is deleted and the information regarding the 101^{st} visited web page is stored. Alternatively, the controller 1150 may count a visit frequency of the pre-visited web page, maintain the information regarding the pre-visited web page which is frequently visited, and delete information regarding a pre-visited web page which is less visited, when the buffer space is full.

Meanwhile, when the electronic apparatus 1100 stores the information regarding the pre-visited web page in the memory 1140, it is anticipated that the electronic apparatus 1100 will enter the communication shadowing region and the information regarding the pre-visited web page may be stored only when it is anticipated that the electronic apparatus 1100 will enter the communication shadowing region according to an anticipated result.

For example, the electronic apparatus 1100 may judge whether the electronic apparatus 1100 will enter the communication shadowing region by using the map data. The controller 1150 may acquire a current position, and a movement direction and a movement velocity. The controller 1150 may acquire the current position, the movement direction, and the movement velocity through communication with a Wi-Fi access point by the short-distance communication module in the communication module 1140, the GPS signal through the satellite communication module, or the acceleration sensor or the gyro sensor installed in the electronic apparatus 1150. The controller 1150 may judge whether a position after the current time is within the communication shadowing region by using the map data based on the current position, the movement direction, and the movement velocity. For example, when the current movement direction is toward the communication shadowing region at the current position on the map data, the controller 1150 may judge that the electronic apparatus will enter the communication shadowing region. Alternatively, the controller 1150 may judge that the electronic apparatus 1100 will enter the communication shadowing region when the current position on the map data is within a predetermined distance from the communication shadowing region. Meanwhile, herein, a part or the entirety of the process of judging whether the electronic apparatus 1100 enters the communication shadowing region may be performed by the server 1200 instead of the electronic apparatus 1100 and the electronic apparatus 1100 may acquire the judgment through communication with the electronic apparatus 1100.

When it is anticipated that the controller 1150 will enter the communication shadowing region, the information regarding the web page which is visited through the on-line mode is stored in the memory 1140, and when it is not anticipated that the electronic apparatus 1100 will enter the communication shadowing region, even though the web page is visited through the on-line mode, the information regarding the web page may not be stored.

Since all of the steps are not required in the method for loading a web page described above, a web page requesting method may be performed while some of the steps are skipped and further, since the steps need not particularly performed only in the aforementioned order, and as a result, the steps described later may be performed earlier than the steps described earlier.

Hereinafter, a method for performing data streaming according to an exemplary embodiment of the present invention will be described. Herein, it will be described that the method for performing the data streaming according to the exemplary embodiment of the present invention is performed by the web system 1000 including the electronic device 1100 and the server 1200 (streaming server). However, the description is only for convenience of description, and the method for performing the data streaming is not particularly performed only by the electronic device 1100 and the server 1200 and may be performed by another device or system which is the same as or similar to the electronic device 1100 and the server 1200.

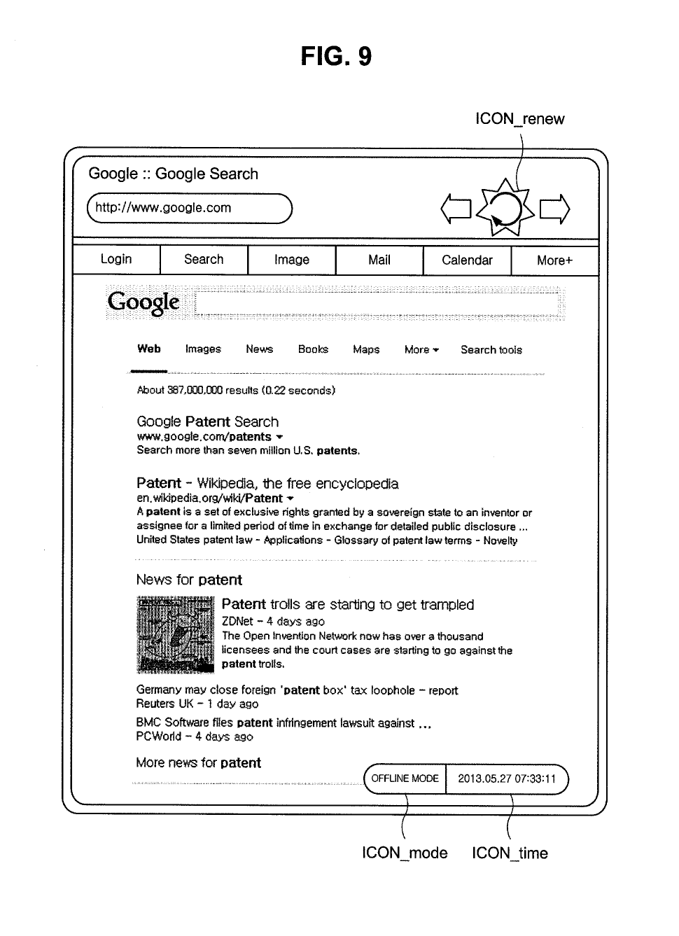

FIG. 10 is a flowchart of a method for performing data streaming according to an exemplary embodiment of the present invention.

Referring to FIG. 10, the method for performing data streaming according to the exemplary embodiment of the present invention may include starting a streaming service of multimedia contents (S210), determining whether the electronic device will enter a communication shadowing region (S220), setting the size of a streaming buffer according to a determining result (S230), receiving data regarding the multimedia contents and storing the received data in the streaming buffer (S240), and reproducing the multimedia contents by using the data stored in the streaming buffer (S250). Hereinafter, the aforementioned respective steps will be described in detail.

First, the streaming service of the multimedia contents may be started (S210).

An electronic device 1100 first requests selecting and reproducing multimedia contents to be enjoyed, and as a result, the streaming service of the multimedia contents may be started. For example, the electronic device 1100 may display a web page providing a list of the multimedia contents through web browsing. A user may select multimedia contents which the user intends to enjoy from the provided list and an input module 1110 may resultantly receive a user input to select the multimedia contents. When the multimedia contents are selected, a controller 1150 transmits a signal for requesting selecting the multimedia contents to the server 1200 through a communication module 1130 and the server 1200 transmits a web page for reproducing the multimedia contents to the electronic device 1100. The controller 1150 may receive the web page through the communication module 1130 and prepare for reproducing the multimedia contents by using an application that reproduces the multimedia contents, such as a plug-in or a media player. When the input module 1110 receives the user input instructing the reproduction of the multimedia contents, the controller 1150 requests streaming the data of the multimedia contents to the server 1200 through the communication module 1130. As a result, the streaming service of the multimedia contents may be started.

Next, it may be determined whether the electronic device 1100 will enter the communication shadowing region (S220).

Herein, the communication shadowing region may represent a region where wireless communication through the mobile communication network or the wireless short-range communication network is not smoothly performed. For example, the communication shadowing region may represent a region which is out of coverage of mobile communication network or the wireless short-range communication network or where data transmission and reception are impossible or a network speed is low due to a weak communication signal. Since the electronic device 1100 may not access an Internet network or the network speed is lower than a bit rate of the multimedia contents even though the electronic device 1100 accesses the Internet network, buffer underrun occurs, and as a result, it may be difficult for the streaming service of the multimedia contents to be in smooth progress.

According to one example, determining whether the electronic device will enter the communication shadowing region may be performed based on intensity of a communication signal.

First, the communication module 1130 may sense the intensity of the communication signal. For example, the mobile communication module may sense intensity of a mobile communication signal such as LTE or the short-range communication module may sense intensity of a Wi-Fi signal irradiated from a neighboring access point. The controller 1150 may determine that the electronic device will enter the communication shadowing region when the communication module 1130 does not sense the communication signal or when the intensity of the sensed communication signal is equal to or less than a predetermined reference value. Alternatively, the controller 1150 may determine whether the electronic device will enter the communication shadowing region based on a change of the intensity of the communication signal sensed by the communication module 1130. In detail, the controller 1150 may determine that the electronic device will enter the communication shadowing region when the sensed intensity of communication signal is reduced.

According to another example, determining whether the electronic device will enter the communication shadowing region may be performed based on position information on a position of the electronic device and movement information.

The electronic device 1100 may first acquire the position information on the position of the electronic device. For example, the controller 1150 may receive a GPS signal through the communication module 1130 having a satellite communication module function and calculate the present position based on the received GPS signal. As another example, the controller 1150 may receive a communication signal from a Wi-Fi AP through the communication module 1130 having a short-range communication module function, sense the intensity of the communication signal, and measure the present position by using the intensity or receive the position information on the position of the electronic device from a web.

Further, the electronic device 1100 may acquire movement information including at least one of a movement speed and a movement direction. For example, the controller 1150 may calculate the movement speed or the movement direction by using information sensed by a gyroscope sensor or an acceleration sensor installed in the electronic device 1100. As another example, the controller 1150 may also acquire the movement information by calculating the movement speed or the movement direction by acquiring position information at different points of time.

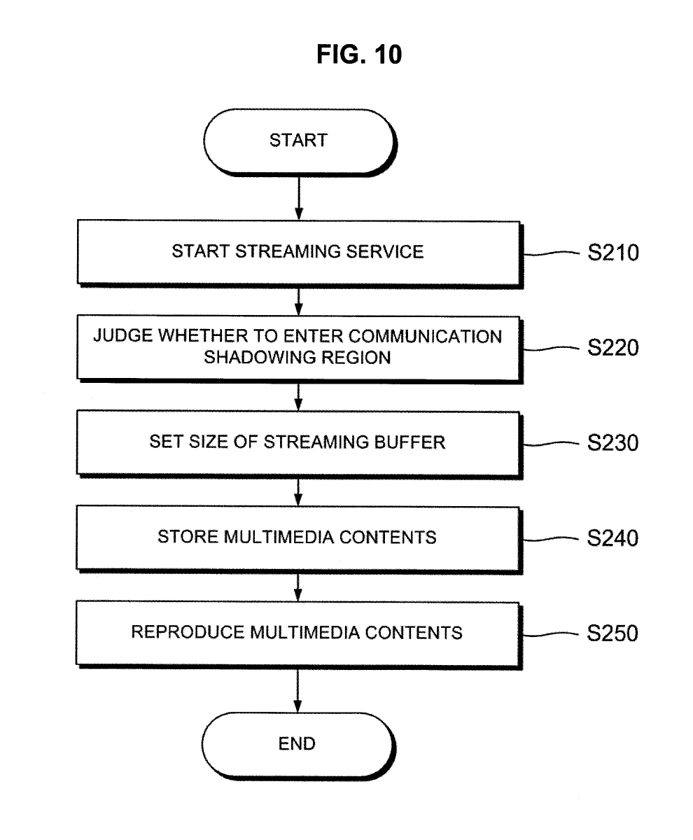

When the position information and the movement information are acquired, the electronic device 1100 may determine whether the electronic device will enter the communication shadowing region by using the position information and the movement information, and map data. The map data may be stored in a memory 1140. Herein, the map data may include information on a region corresponding to the communication shadowing region in a map, information on a region where the communication signal is weak, or information regarding whether a corresponding region corresponds to the communication shadowing region or information on the intensity of the communication signal for each region. FIG. 11 illustrates one example of map data according to an exemplary embodiment of the present invention. The controller 1150 may determine whether the electronic device will enter the communication shadowing region on the map data when the electronic device 1100 moves in the movement direction depending on the movement information at the present position depending on the position information. Referring to FIG. 11, when the present position is point A according to the position information and the electronic device 1100 moves on trajectory a according to the movement information, the controller 1150 may determine whether the electronic device will enter the communication shadowing region. Further, referring to FIG. 11, when the present position is point B and the electronic device 1100 moves on trajectory b, the controller 1150 may determine that the electronic device 1100 will not enter the communication shadowing region. Further, the controller 1150 may determine that the electronic device 1100 will enter the communication shadowing region when a distance between the communication shadowing region and the present position is equal to or smaller than a predetermined distance and the movement direction is toward the communication shadowing region. For example, when the present position is point C within a predetermined distance d from the communication shadowing region and the movement direction is c, the controller 1150 may determine that the electronic device 1100 will enter the communication shadowing region, and contrary to this, when the present position is point C and the movement direction is c′, the controller 1150 may determine that the electronic device 1100 will not enter the communication shadowing region. In this case, the predetermined distance may be increased or decreased based on the movement speed. The controller 1150 may increase the predetermined distance when the movement speed is high and decrease the predetermined distance when the movement speed is low.

Alternatively, when the position information and the movement information are acquired, the electronic device 1100 may transmit the position information and the movement information to a server that is in charge of measuring a position on the Internet and receive information regarding whether the electronic device will enter the communication shadowing region from the server that is in charge of the measuring the position. For example, the controller 1150 may transmits the received position information and movement information to an external device through the communication module 1130, the external device may determine whether the electronic device 1100 will enter the communication shadowing region by using the position information and the movement information and map data stored in the external apparatus, and the controller 1150 may receive the determining result from the external device through the communication module 1130 to acquire the information regarding whether the electronic device will enter the communication shadowing region.

According to yet another example, determining whether the electronic device will enter the communication shadowing region may be performed based on the position information on the position of the electronic device.

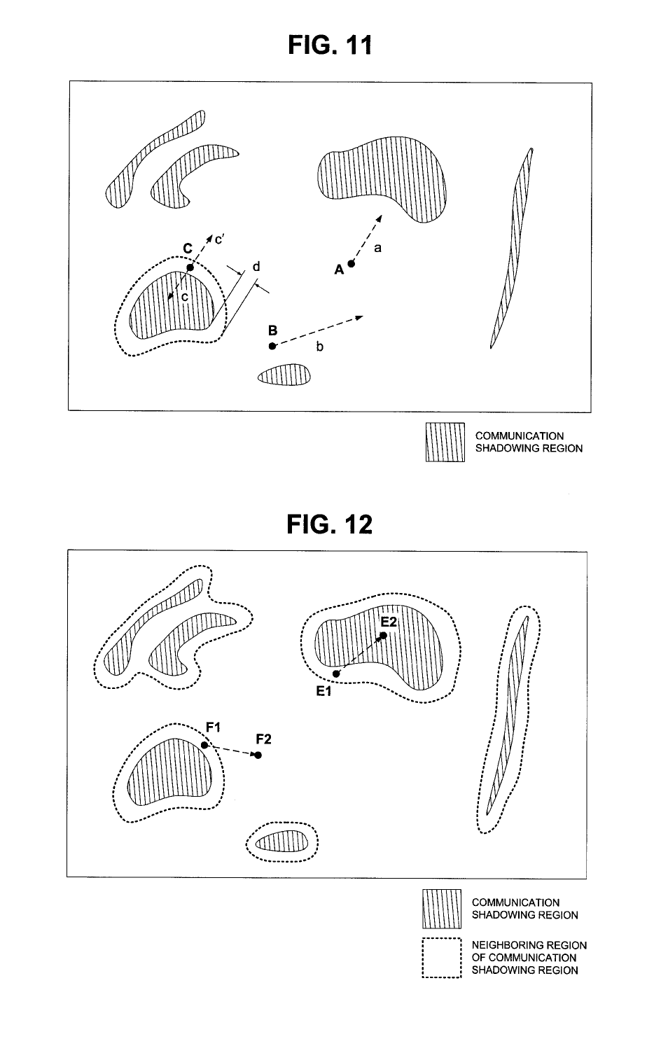

The electronic device 1100 may first acquire the position information on the position of the electronic device. When the electronic device 1100 acquires the position information, the electronic device 1100 may determine whether the electronic device will enter the communication shadowing region by using the map data and the position information stored in the memory 1140. Herein, the map data may include information on the communication shadowing region and a neighboring region of the communication shadowing region in a map. Herein, communication is smoothly made in the neighboring region of the communication shadowing region, but the neighboring region may mean a region which is geographically near the communication shadowing region. FIG. 12 illustrates another example of map data according to an exemplary embodiment of the present invention. The controller 1150 may anticipate that the electronic device 1100 will enter the communication shadowing region when a position at a first point of time depending on the position information is changed to the neighboring region of the communication shadowing region at a second point of time which is later than the first point of time depending on the position information in a region where the communication is smoothly made. For example, in FIG. 12, when the position depending on the position information is changed from point E1 to point E2, the controller 1150 may determine that the electronic device 1100 will enter the communication shadowing region because the electronic device 1100 enters the neighboring region of the communication shadowing region from a general region. On the contrary, in FIG. 12, when the position depending on the position information is changed from point F1 to point F2, the electronic device 1100 moves from the neighboring region of the communication shadowing region to the general region, and as a result, the controller 1150 may determine that the electronic device 1100 will not enter the communication shadowing region.

However, the determining is not directly performed by the controller 1150, but the determining is performed on the web and the electronic device 1100 may receive the information on the determining result through the Internet network.

The electronic device 1100 may set the size of the streaming buffer according to the determining result (S230).

Herein, the streaming buffer means a storage space for storing data of multimedia contents received from the server 1200 in a streaming method. Streamed data may be temporarily stored in a temporary memory such as a RAM, used to reproduce multimedia and thereafter, deleted or may be stored in a hard disk as a file format in the case of a progressive downloading method, and the streamed buffer may be implemented by the memory 1140 physically provided in the form of a RAM or a hard disk as the storage space capable of storing the streamed data in either case.

The controller 1150 may set the size of the streaming buffer based on whether the electronic device will enter the communication shadowing region. For example, when the controller 1150 determines that the electronic device 1100 will enter the communication shadowing region within a predetermined time, the controller 1150 may increase the size of the streaming buffer as compared with the case contrary thereto. This is to prevent the reproduction of the multimedia from being stopped due to the buffer underrun even though the electronic device 1100 does not receive data or a transmission speed of the network is lower than the bit rate of the multimedia contents when entering the communication shadowing region by securing a sufficient amount of data required to reproduce the multimedia contents before entering the communication shadowing region by setting the size of the buffer to a size larger than that of a general case. In other words, in the general case, that is, when the controller 1150 determines that the electronic device 1100 will not enter the communication shadowing region within a predetermined time, the controller 1150 may set the size of the streaming buffer to a first size and when the controller 1150 determines that the electronic device 1100 will enter the communication shadowing region within the predetermined time, the controller 1150 may set the size of the streaming buffer to a second size larger than the first size. As a result, the electronic device 1100 may buffer a large amount of data in advance.

Further, the size of the streaming buffer may be set by further considering a time when entering the communication shadowing region is anticipated. That is, the controller 1150 may set the size of the streaming buffer based on a time which remains until entering the communication shadowing region. When the time is not long until entering the communication shadowing region, the controller 1150 may set an increase amount of the size of the streaming buffer to a large value, and when the time is long, the controller 1150 may set the increase amount of the size of the streaming buffer to a small value. Herein, the controller 1150 may calculate the distance from the present position to the communication shadowing region based on the map data and the position information and calculate a time when entering the communication shadowing region from the present position is anticipated based on the movement direction and the movement speed in addition to the distance and the movement information.

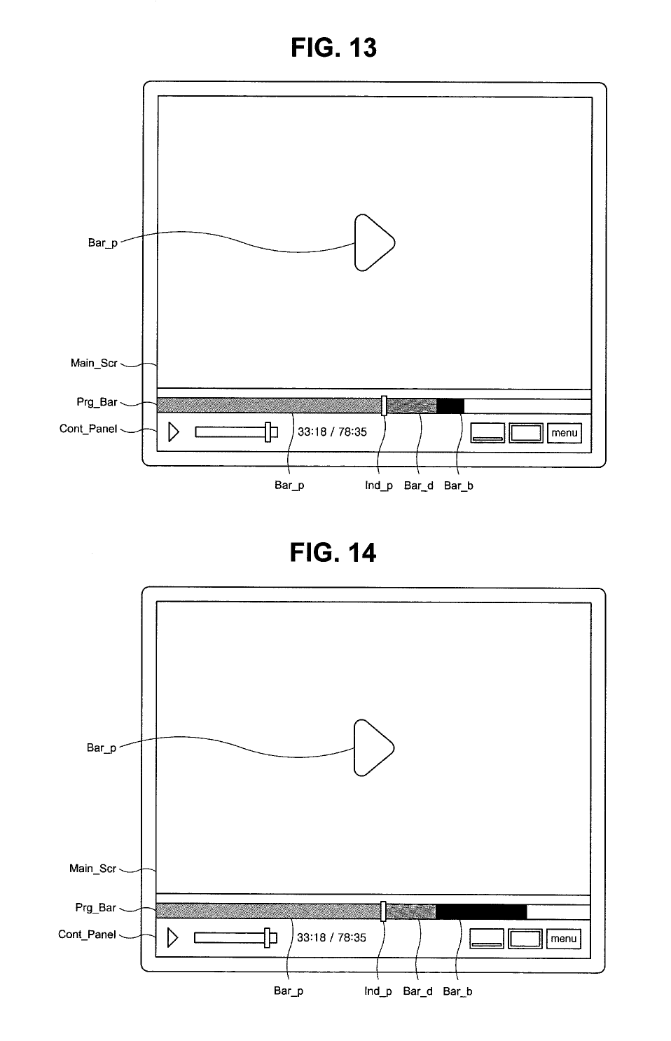

FIGS. 13 and 14 illustrates one example of a reproduction screen of multimedia contents illustrating that the size of a streaming buffer is adjusted according to an exemplary embodiment of the present invention. In detail, in FIGS. 13 and 14, the reproduction screen may include a main screen Main_scr on which multimedia content, which is a moving picture, is reproduced, a control panel Cont_Panel for controlling the reproduction of the multimedia content, and a progress bar Progress_Bar for expressing a reproduction progress status. The main screen Main_Scr may include a reproduction icon Icon_p to simply control reproduction/stop of the multimedia content. Further, the control panel Cont_Panel may include a reproduction icon to control reproduction/stop of the multimedia content, a volume control bar to control a volume, a time display unit to display a time of a point which is being reproduced at present and a total reproduction time, an icon to control subtitles, an icon to change a present screen to a full screen, an icon to allow entering a menu, and the like, sequentially from the left.

The progress bar Prog_Bar may express a present reproduction time or a downloading time of the multimedia content. A user may control a reproduction time by using the progress bar Prog_Bar. In detail, a total length of the progress bar Prog_Bar may correspond to the total reproduction time. Next, the progress bar Prog_Bar may include a reproduction bar Bar_p representing the present reproduction time. Further, an indicator Ind_p to express a progress time or move the reproduction time may be expressed in the progress bar Prog_Bar. Further, the progress bar Prog_Bar may include a download bar Bard representing the amount of data downloaded in the streaming service. In addition, the progress bar Prog_Bar may include a buffer bar Barb representing the size of the streaming buffer.

FIG. 13 is a screen when not entering the communication shadowing region is anticipated or when entering the communication shadowing region is not anticipated. FIG. 14 is a screen when entering the communication shadowing region is anticipated. When FIGS. 13 and 14 are compared with each other, it can be seen that the buffer bar Bar_b is enlarged in FIG. 14 as compared with FIG. 13. This is because the controller 1150 determines that the electronic device will enter the communication shadowing region and increases the size of the streaming buffer. Of course, in some cases, the buffer bar Bar_b is not displayed on a screen but just internally configured in the electronic device 1100 and may not be displayed.

The electronic device 1100 may receive data regarding the multimedia contents to store the received data in the streaming buffer (S240).

The communication module 1130 may receive the data regarding the multimedia contents from the server 1200. Herein, the data regarding the multimedia contents may be transmitted/received between the server 1200 and the electronic device 1100 according to a streaming technique. The controller 1150 may store the data in the streaming buffer received through the communication module 1130. Herein, the streaming buffer may be provided by the memory 1140. In this case, the size of the streaming buffer set in the memory 1140 may be decided according to whether the electronic device enters the communication shadowing region as described above. The controller 1150 continuously receive the data until the size of the received data regarding the multimedia contents reaches the size of the streaming buffer and temporarily stops receiving the data when the size of the stored data is equal to the size of the streaming buffer. Herein, the data stored in the streaming buffer is analyzed by the controller 1150 and used to reproduce the multimedia and the used data is deleted from the streaming buffer. As a result, when the streaming buffer is vacant, the controller 1150 may resume receiving multimedia data again.

The electronic device 1100 may reproduce the multimedia (S250).

The controller 1150 may reproduce the multimedia contents by using the data of the multimedia contents stored in the streaming buffer. Herein, the controller 1150 may download all files of the multimedia contents and then substantially reproduce the multimedia contents in real time simultaneously with receiving the data of the multimedia contents by using only a received data part without reproducing the files.

Meanwhile, it has been described above that determining whether the electronic device will enter the communication shadowing region (S220), setting the size of the streaming buffer according to a result of the determining (S230), receiving the data of the multimedia contents (S240), and reproducing the data (S250) are sequentially performed, but steps S220 and S230 may be performed cyclically or in real time even while the streaming service is continued, that is, steps S240 and S250 are in progress. Further, steps S220 and S230 may be simultaneously performed. As a result, when the size of the streaming buffer is adaptively changed in step S230, the streaming buffer storing the received data may be changed while step S240 is performed. In other words, the size of the streaming buffer may be adjusted in real time or cyclically even while the data of the multimedia contents are transmitted.

Further, the setting of the size of the streaming buffer (S230) may also be performed by not the electronic device 1100 but the server 1200. In this case, the controller 1150 of the electronic device 1100 may transmit information regarding whether the electronic device will enter the communication shadowing region to the server 1200 through the communication module 1130, and the sever 1200 may adjust the size of the streaming buffer by using the information or the size of the data of the multimedia contents transmitted to the electronic device 1100.

Similarly, the determining whether the electronic device will enter the communication shadowing region (S220) may also be performed by not the electronic device 1100 but the server 1200. For example, the server 1200 may determine whether the electronic device enters the communication shadowing region by receiving position information, or the like from the electronic device 1100 and referring to map data stored in the server 1200 or a database server (not illustrated) based on the received position information, or the like.

Since all of the steps are not required in the data streaming method described above, the data streaming method may be performed while some of the steps are skipped and further, since the steps need not particularly performed only in the aforementioned order, and as a result, the steps described later may be performed earlier than the steps described earlier.

According to exemplary embodiments of the present invention, a sufficient amount of data is streamed in a streaming buffer in advance in spite of entering a communication shadowing area, and as a result, a user can seamlessly enjoy multimedia contents.

It will be appreciated that various embodiments of the present invention have been described herein for purposes of illustration, and that various modifications, changes, substitutions may be made by those skilled in the art without departing from the scope and spirit of the present invention. Therefore, the exemplary embodiments of the present invention described above may be implemented separately or combinationally.

Accordingly, the various embodiments disclosed herein are not intended to limit the technical spirit but describe with the true scope and spirit being indicated by the following claims. The scope of the present invention may be interpreted by the appended claims and the technical spirit in the equivalent range is intended to be embraced by the invention.

What is claimed is:

1. An electronic apparatus, comprising:
a display;
a communication module configured to perform communication with a web server;
a memory configured to store information regarding a pre-visited web page; and
a controller configured to
judge whether a corresponding region is a communication shadowing region,
receive a request signal for requesting a target web page,
set a web page loading mode, which includes a first mode to acquire web page data regarding the target web page by referring to information regarding the pre-visited web page stored in the memory and a second mode to acquire the web page data regarding the target web page from the web server through the communication module, based on whether the corresponding region is the communication shadowing region,
acquire the web page data regarding the target web page according to the set web page loading mode, and
display the target web page through the display by using the acquired target web page data.

2. The electronic apparatus of claim 1, wherein:
the controller
sets the web page loading mode to the first mode when the corresponding region corresponds to the communication shadowing region, and
sets the web page loading mode to the second mode when the corresponding region does not correspond to the communication shadowing region.

3. The electronic apparatus of claim 2, wherein:
the controller
displays the target web page by acquiring the web page data regarding the target web page according to the second mode as the corresponding region corresponds to the communication shadowing region, and newly acquires the web page data regarding the target web page according to the second mode when the corresponding region does not correspond to the communication shadowing region, and
displays the target web page through the display by using the newly acquired target web page data.

4. The electronic apparatus of claim 1, wherein the controller judges whether the corresponding region is the communication shadowing region, based on strength of a communication signal of the communication module.

5. The electronic apparatus of claim 4, wherein the communication module includes at least one of a mobile communication module performing communication by using a mobile communication network and a short-range communication module performing communication by using a short-range communication network.

6. The electronic apparatus of claim 1, wherein:
the memory stores the map data regarding the communication shadowing region, and
the controller acquires positional information regarding a current position and judges whether the corresponding region is the communication shadowing region, by using the map data and the positional information.

7. The electronic apparatus of claim 6, wherein the controller calculates the positional information based on a GPS signal or a Wi-Fi signal.

8. The electronic apparatus of claim 1, wherein the controller displays an icon, which reflects whether the web page data regarding the target web page is acquired according to any mode of the first mode and the second mode, together with the target web page through the display.

9. The electronic apparatus of claim 1, wherein the controller adjusts a display attribute of the target web page according to whether the web page data regarding the target web page is acquired according to any mode of the first mode and the second mode.

10. The electronic apparatus of claim 1, wherein:
information regarding the pre-visited web page includes time information regarding a time of visiting the pre-visited web page, and
the controller displays the time of visiting the visited web page or a time different from a current time to the visitation time by using the time information, together with the target web page through the display, when the web page loading mode is set to the first mode.

11. The electronic apparatus of claim 1, wherein the controller judges whether the corresponding region is to enter the communication shadowing region, updates the information regarding the pre-visited web page by using the data regarding the target web page received through the second mode, and determines whether the updating is performed based on whether the corresponding region is to enter the communication shadowing region.

12. A method for loading a web page, comprising:
judging whether a corresponding region is a communication shadowing region;
receiving a signal for requesting a target web page;
setting a web page loading mode, which includes a first mode to acquire web page data regarding the target web page by referring to information regarding a pre-visited web page stored in a memory and a second mode to acquire the web page data regarding the target web page through communication with a web server, based on whether the corresponding region is the communication shadowing region;
acquiring the web page data regarding the target web page according to the set web page loading mode; and
displaying the target web page by using the acquired web page data.
